(19) United States
(12) Patent Application Publication
(10) Pub. No.: US 2024/0303622 A1
(43) Pub. Date: Sep. 12, 2024

(54) SYSTEMS AND METHODS FOR REMOTE TRANSACTION CONTROL USING A HIERARCHICAL DATA STRUCTURE

(71) Applicant: U.S. Bancorp, National Association, Minneapolis, MN (US)

(72) Inventors: Valerie F. Lancelle, Caledonia, WI (US); James Andrew Cantrell, Duluth, GA (US); Utthej Nukala, Alpharetta, GA (US); Todd C. Moning, Victoria, MN (US)

(73) Assignee: U.S. Bancorp, National Association, Minneapolis, MN (US)

(21) Appl. No.: 18/119,517

(22) Filed: Mar. 9, 2023

(51) Int. Cl. G06Q 20/22; G06Q 20/38; G06Q 20/40

(52) U.S. Cl. CPC G06Q 20/2295; G06Q 20/3821; G06Q 20/4014; G06Q 2220/00

(57) ABSTRACT

A method comprises storing a data structure including a parent profile comprising a parent value linked with one or more child profiles, each child profile comprising a child restriction and a child value linked with the parent value, the child restriction and the child value configured by an account associated with the parent profile; receiving a transaction request comprising a value, a transaction attribute, and an identifier of a first child profile of the child profiles; determining whether to facilitate a transaction of the transaction request based on the value, a first child value of the first child profile, the transaction attribute, and a first child restriction of the first child profile; and transmitting a data packet to the computing device restricting the transaction from occurring. The child value or the parent value can be a sum of values of different types.

### BACKGROUND

Facilitating transactions at brick-and-mortar stores and on websites is often a static process that involves little else than transmitting an identifier of a transaction card and a value for a transaction to a remote server and receiving an indication of whether the transaction can be performed. The remote server can control whether to enable or restrict transactions based on the value in an account for the transaction card. Computers that transmit the data for the transactions to the remote server may not have any data to locally determine whether to enable or restrict transactions because of the sheer number of cardholders there may be that may each have different cards and/or accounts with values. Further, the owners of the accounts may not have accessed any electronic platform for the local computers to receive the data prior to the transactions.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an illustration of an example system for remote transaction control, in accordance with an implementation;

FIG. 2 is an illustration of an example method for remote transaction control, in accordance with an implementation;

FIG. 3 is an illustration of an example system for remote transaction control, in accordance with an implementation; and

FIG. 4 is an illustration of an example method for remote transaction control, in accordance with an implementation.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

As previously mentioned, the transaction management process is often a computer-based process in which a point-of-sale computing device facilitating a transaction transmits a message to a remote computer with an identifier of a transaction card. Such a message can also include a value for a transaction. The remote computer can identify an account stored in memory based on the identifier and identify a value for the account in the data structure of the account. The remote computer can transmit an indication to the point-of-sale computing device based on whether the value in the account exceeds the value of the transaction.

While the value in the account can be adjusted by the user of the account, the remote computer and point-of-sale computing device have little other control over whether to enable or restrict transactions. While the remote server can store the accounts and values for the accounts in various data structures, the remote computer and users of the remote computer have little control over how to facilitate transactions. Point-of-sale computing devices often do not have the memory resources to store the data to facilitate the transactions or the processing resources to secure such data from malicious entities (e.g., hackers that seek to steal the data). Thus, point-of-sale computing devices and the remote server provide users with little customizability or ability to control how the remote server and point-of-sale devices operate together to enable or restrict transactions on a transaction-by-transaction basis.

Implementations of the systems and methods discussed herein overcome these technical deficiencies because they provide a method for remotely controlling transactions. A computer implementing the systems and methods described herein can store one or more hierarchical data structures for different sets of parent profiles and/or child profiles. An account can be linked with a parent profile that controls the different parameters and/or rules of both the parent profile itself and one or more child profiles that are linked to the parent profile. A user of the account can access the parent profile and child profiles using a single set of log-in credentials. Upon logging in, the user can input restrictions into the child profiles that are linked with the parent profile. The computer can insert the restrictions in the data structure for the child profiles and/or the parent profile. The restrictions can include various transaction parameters indicating transactions that can and cannot be performed through the child profiles. Accordingly, when the computer receives a transaction request from a point-of-sale computing device containing an identifier of one of the child profiles, the computer can determine whether to enable or restrict the transaction of the transaction request based on the restrictions stored in the data structure for the child profile. Based on the restrictions, the computer can transmit a message to the point-of-sale computing device with instructions that cause the point-of-sale computing device to enable or restrict the transaction. Accordingly, the user of the parent profile and account can enable the computer implementing the systems and methods described herein to have a higher level of control than conventional computers that simply rely on values in static accounts or profiles.

Links between the child profiles and a parent profile of a hierarchical data structure can enable third parties to control access to the various profiles. For example, the computer implementing the systems and methods described herein can receive a message containing a value from a client device. The message can contain the value and an identifier of a parent profile and/or a child profile that is linked with such a parent profile. Responsive to receiving the message, the computer can identify the child profile and/or parent profile based on the identifier or identifiers in the message. The computer can add the value in the message to a value in the child profile and/or, separately, to a value in the parent profile. In some instances, the message may only contain an identifier of the child profile. In such instances, the computer can identify and add the value to the parent profile based on an identifier or other link stored in the data structure for the child profile. The computer can similarly add values to other child profiles linked to the same parent profile based on similar messages. A user of an account associated with the parent profile can insert restrictions into the linked child profiles indicating restrictions on how the child profiles can be used. The user can also or instead redistribute values between child profiles. The computer can determine and control point-of-sale devices for transactions performed by the child profiles based on the values and restrictions. Accordingly, the computer can have a greater degree of control over transactions performed at point-of-sale computing devices.

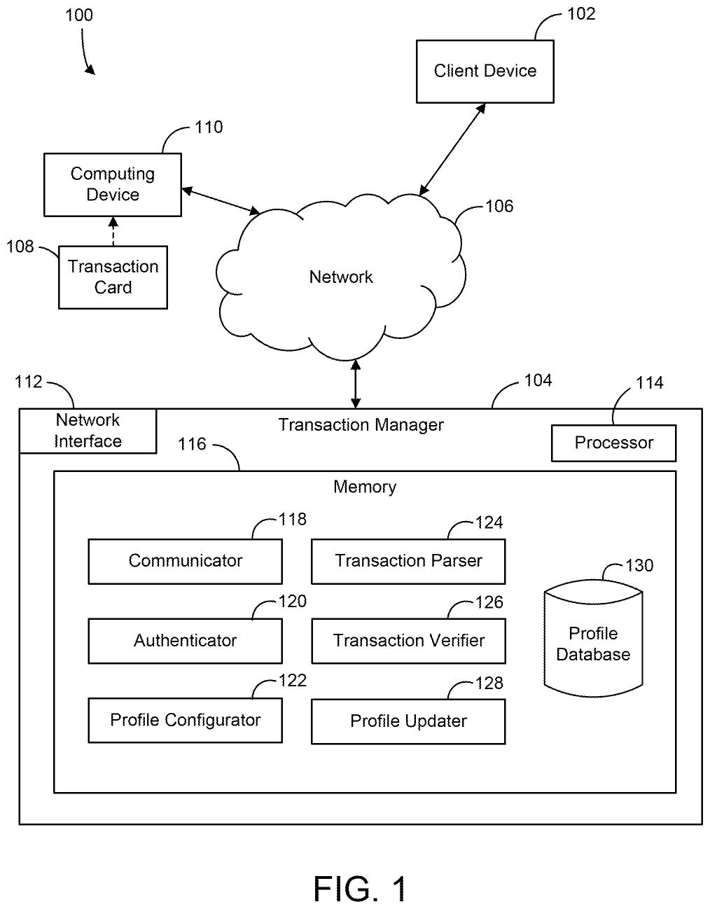

FIG. 1 illustrates an example system 100 for remote transaction control, in some embodiments. In brief overview, the system 100 can include a client device 102 that communicates with a transaction manager 104 over a network 106. The client device 102 can transmit the transaction manager 104 configurations and restrictions for parent profiles and/or child profiles. The transaction manager 104 can receive and store the configurations and restrictions in a hierarchical data structure in which an account associated with the parent profile can add or change restrictions of child profiles associated or linked with the parent profile. A user can initiate a transaction using a transaction card 108 at a computing device 110. The computing device 110 can transmit details of the transaction and/or the transaction card 108 to the transaction manager 104. The transaction manager 104 can identify the attributes of the transaction and/or the transaction card 108, identify a child profile for the transaction card 108, and determine whether to restrict or enable the transaction based on the transaction attributes and/or restrictions in the child profile. The transaction manager 104 can transmit a message to the computing device 110 restricting or enabling the transaction based on the determination. These components may operate together to facilitate transactions. The system 100 may include more, fewer, or different components than shown in FIG. 1. For example, there may be any number of client devices or computers that make up or are a part of the transaction manager 104 or networks in the system 100.

The client device 102, the transaction manager 104, and/or the computing device 110 can include or execute on one or more processors or computing devices and/or communicate via the network 106. The network 106 can include computer networks such as the Internet, local, wide, metro, or other area networks, intranets, satellite networks, and other communication networks such as voice or data mobile telephone networks. The network 106 can be used to access information resources such as web pages, websites, domain names, or uniform resource locators that can be presented, output, rendered, or displayed on at least one computing device (e.g., the client device 102 or the computing device 110), such as a laptop, desktop, tablet, personal digital assistant, smartphone, portable computers, or speaker. For example, via the network 106, the computing device 110 can transmit transaction requests to the transaction manager 104, and the transaction manager 104 can enable or restrict transactions that correspond to the transaction requests.

The client device 102, the transaction manager 104, and/or the computing device 110 can include or utilize at least one processing unit or other logic devices such as a programmable logic array engine or a module configured to communicate with one another or other resources or databases. As described herein, computers can be described as computers, computing devices, or client devices. The client device 102 and/or the computing device 110 may contain a processor and a memory. The components of the client device 102, the transaction manager 104, and/or the computing device 110 can be separate components or a single component. The system 100 and its components can include hardware elements, such as one or more processors, logic devices, or circuits.

The computing device 110 can be a point-of-sale device (e.g., a point-of-sale computing device). For example, the computing device 110 can include a register at a brick-and-mortar store or a server in the cloud that facilitates transactions for online stores. The computing device 110 can be configured to receive a request for an item purchase in a transaction. The computing device 110 can identify attributes of the items (e.g., value, item type, number of items, etc.) and/or other attributes of the transaction (e.g., time of the transaction, geographical location of the transaction, type of the transaction (e.g., online or at a brick-and-mortar store), total value of the transaction, etc.) and transmit the attributes of the transaction and/or an identifier of a profile (e.g., an identifier of the transaction card 108 that was used to initiate the transaction) to the transaction manager 104 in a transaction request.

The transaction manager 104 may comprise one or more processors that are configured to remotely control whether to restrict or enable transactions performed at various computing devices, such as the computing device 110. The transaction manager 104 may comprise a network interface 112, a processor 114, and/or memory 116. The transaction manager 104 may communicate with client device 102 and the computing device 110 via network interface 112, which may be an antenna or other network device that enables communication across a network and/or with other devices. The processor 114 may be or include an ASIC, one or more FPGAs, a DSP, circuits containing one or more processing components, circuitry for supporting a microprocessor, a group of processing components, or other suitable electronic processing components. In some embodiments, the processor 114 may execute computer code or modules (e.g., executable code, object code, source code, script code, machine code, etc.) stored in the memory 116 to facilitate the activities described herein. The memory 116 may be any volatile or non-volatile computer-readable storage medium capable of storing data or computer code.

The memory 116 may include a communicator 118, an authenticator 120, a profile configurator 122, a transaction parser 124, a transaction verifier 126, a profile updater 128, and/or a profile database 130, in some embodiments. In brief overview, the components 118-130 may cooperate to store profiles in a hierarchical data structure in which parent profiles control the restrictions of child profiles linked to the parent profiles. The components 118-130 can receive a transaction request for a transaction and attributes for the transaction from a computing device, apply rules (e.g., restrictions) to the transaction attributes, determine whether to restrict or enable transactions based on the application of the rules, and transmit messages enabling or restricting the transaction based on the determination.

The transaction manager 104 may store profiles in the profile database 130. The profile database 130 can be or include a relational or hierarchical database. Profiles may be or include accounts for different individuals such as bank accounts, credit card accounts, user profiles with different websites, etc. The profiles can each be or include a separate record (e.g., a collection of fields and/or values in attribute-value pairs). The profiles may include attribute-value pairs that each include a different attribute and a value for the attribute. For example, the profiles may include attribute-value pairs for first name, last name, full name, address, phone number, cell phone number, home phone number, tax identification number, street name, zip code, city, state, account number, household identification number, group entity number, company identification number, etc. The entity profiles can also include values (e.g., numerical values in value attribute-value pairs). The transaction manager 104 may initially store the profiles with attribute-value pairs with blank values in the data structures for the respective profiles. The transaction manager 104 may then add values to the attribute-value pairs as the transaction manager 104 receives inputs (e.g., user inputs) indicating the values. The transaction manager 104 may add the values to the attribute-value pairs by updating the respective data structures with the values.

The profile database 130 can store restrictions in the profiles. A restriction can be or include one or more rules that indicate whether a profile can be used to perform a transaction. The transaction manager 104 can receive transaction requests in messages that each contain an identifier of a profile and data for the transaction. The transaction manager 104 can identify a profile in the profile database 130 based on the identifier of the profile in the transaction request and retrieve any restrictions and/or the value of the profile from the data structure containing the profile. The transaction manager 104 can compare the data for the transaction to the restrictions and/or the value of the profile to determine whether to enable or restrict the transaction.

Restrictions can be or include rules for different types of transaction data. For example, the restrictions can indicate the times that transactions can or cannot be performed, the types of items that can or cannot be purchased, the types of group entities (e.g., merchant category codes (MCCs)) from which items can or cannot be purchased, the locations (e.g., the latitude and longitude location or region) at which items can or cannot be purchased, the stores at which the items can or cannot be purchased, minimum or maximum values of purchases either per item or per total transaction, or any other type of rule or restriction. Such restrictions can be stored in the data structure for profiles as strings, values, or code (e.g., if-then statements). Items can be or include objects. The restrictions can be stored or otherwise associated with individual profiles by being stored in a data structure or record that is dedicated to (e.g., only stores data for) the specific profiles. For example, the restrictions can be stored in a specific location in a data structure that is dedicated to the specific profiles or be stored with links (e.g., identifiers) of the profiles to which the restrictions correspond. For example, data for a profile can be stored within different cells of a row dedicated to the profile (e.g., containing an identifier of the profile). Restrictions for a single profile can be stored in the same row.

The restrictions can be positive or negative (e.g., either indicate instances in which transactions can be performed or instances in which transactions cannot be performed). For example, a restriction can include a time frame of 5 PM to 10 PM. The time frame can indicate a time period in which the profile can be used to perform a transaction or a time period in which the profile cannot be used to perform a transaction. In another example, a restriction can include a list of MCCs indicating the types of group entities from which items or objects can or cannot be purchased. Any type of restrictions can indicate instances in which transactions can or cannot be performed.

The profile database 130 can store profiles as parent profiles and child profiles in one or more hierarchical data structures. In one of the hierarchical data structures, a parent profile can be linked to one or more child profiles. The parent profile can be linked with the one or more child profiles through identifiers of the linked profiles. For example, the parent profile can include identifiers (e.g., numerical or alphanumerical values) of any child profiles to which the parent profile is linked and/or child profiles can include identifiers of parent profiles to which the child profiles are linked. In one example, child profiles can be stored in separate tables from the parent profiles and each include an identifier of the parent profile to which the child profile is linked. An account associated with (e.g., linked with) a parent profile can access or have permissions to change values of child profiles that are linked to the parent profile.

Values of the parent profiles and the child profiles linked with the parent profiles can be linked. For example, a parent profile can include a value (e.g., a parent value). A user of an account associated or otherwise linked with the parent profile can allocate portions of the value of the parent profile to each of the child profiles. The user can do so by providing an input (e.g., via an input/output device, such as a touchpad or a mouse) at the client device 102 indicating amounts (e.g., values) to allocate to each of the child profiles. The computing device can transmit an indication of the amounts to the transaction manager 104. The transaction manager 104 can receive and store the allocations in the respective child profiles as values for the child profiles.

In some embodiments, a value of a profile (e.g., a parent profile and/or a child profile) can be a combination of different types of values (e.g., cash, credit, points, cryptocurrencies, or other formats of values). For example, for a child profile, the data processing can store a value of a first type (e.g., cash) and a value of a second type (e.g., credit, points, or a cryptocurrency). The value of the profile can be a sum of the two types of values. The child profile can store any number of types of values and the value of the profile can be a sum of any number of types of values. The data processing system can store values of any number of types to aggregate to the value of a profile.

Different types of values can be used to complete a transaction using a profile (e.g., a parent profile and/or a child profile). For example, a child profile can store a value of a first type and a value of a second type. The transaction manager 104 can receive a request from a computing device to perform a transaction through the child profile (e.g., a transaction request including an identifier of the child profile). The request can include a transaction value that is higher than the value of the first type but lower than a sum of the value of the first type and the value of the second type of the child profile. The transaction manager 104 can determine the transaction can be complete responsive to determining the sum is greater than the transaction value. The transaction manager 104 can complete or facilitate the transaction by subtracting the value of the first type from the transaction value to determine a remaining transaction value, reducing the value of the first type to zero, subtracting the remaining transaction value from the value of the second type, and reducing the remaining transaction value to zero. The transaction manager 104 can then transmit a message to the device from which the transaction manager 104 received the transaction request to complete or otherwise facilitate the transaction.

The values of the different types can have a priority order. The priority order can indicate an order of the types of values to update for a successful transaction (e.g., enabled or not restricted transaction). For example, a first type of value can have a higher priority than a second type of value for a profile. A transaction can be approved for the transaction. The data processing system can subtract the value of the transaction from the first type of value before subtracting any values from the second type of value. If the value of the transaction is greater than the value of the first type of value, the data processing system can subtract all of the value of the first type of value and then subtract the remainder of the value for the transaction from the second type of value. Such a priority order can be configured by the account associated with the child profile and/or the account associated with the parent profile.

The communicator 118 may comprise programmable instructions that, upon execution, cause the processor 114 to receive a transaction request from computing devices (e.g., the computing device 110). The communicator 118 may be or include an application programming interface (API) that facilitates communication between the transaction manager 104 and other computing devices.

The communicator 118 can establish connections with computers. The communicator 118 can establish the connections with the computers over a network (e.g., the network 106). To do so, the communicator 118 can communicate with the computers across the network. In one example, the communicator 118 can transmit syn packets to the computers (or the computers can transmit syn packets to the communicator 118) and establish the connections using a TLS handshaking protocol. The communicator 118 can use any handshaking protocol to establish connections with the computers.

The authenticator 120 may comprise programmable instructions that, upon execution, cause the processor 114 to authenticate users of accounts. The authenticator 120 can authenticate account data for individuals accessing client devices to access accounts of an electronic platform that the transaction manager 104 provides. For example, the authenticator 120 can transmit a user interface for a “log-in screen” to the client device 102. The user interface can include fields for authentication (e.g., a username field and a password field). A user accessing the client device 102 can input account credentials (e.g., username and password) of an account into the fields on the user interface. The user can select a “send” or “log in” option at the user interface. Responsive to the selection, the client device 102 can transmit the account credentials to the transaction manager 104 through the communicator 118 and the authenticator 120 can receive the account credentials.

The authenticator 120 can authenticate the account credentials. To do so, the authenticator 120 can compare the account credentials to stored account credentials in the memory 116. In one example, the authenticator 120 can use the username of the account credentials as a lookup to identify stored account credentials for the account into which the user is logging in. The authenticator 120 can identify the password associated with the identified username and compare the input password with the password the authenticator 120 received in the received account credentials. In some embodiments, for security, the password can be stored as a hash (e.g., hashed via MD5, CRC32, SHA-2, SHA-128, or SHA-256). In such cases, the authenticator 120 can calculate a hash of the password of the received account credentials using the same hashing function as the function that was used to generate the stored hashed password and compare the hashes. Responsive to determining the passwords match (e.g., are the same or identical) based on the comparison, the authenticator 120 can determine the account credentials are authentic. The authenticator 120 can transmit a message to the client device 102 indicating the successful authentication. The authenticator 120 can transmit a user interface to the client device 102 at which the user can access the electronic platform.

The electronic platform can be or include an application, website, or service at which users can access accounts or profiles. Users can perform transactions through the accounts or profiles. An account can be the same as a profile or be an account through which an individual can access one or more defined profiles. For example, an individual can log into an account with the electronic platform that is associated with a parent profile and/or child profiles linked with the parent profile. The electronic platform can be a website. The individual can navigate through different user interfaces or pages (e.g., web pages) of the platform to view data regarding transactions performed by the different profiles and/or other data regarding the profiles, such as restrictions on the profiles.

The profile configurator 122 may comprise programmable instructions that, upon execution, cause the processor 114 to configure parent and/or child profiles in the profile database 130. The profile configurator 122 can configure a parent profile or one or more child profiles linked to the parent profile responsive to receiving inputs from an account associated with the parent profile (e.g., an account that is the parent profile). For example, upon the authenticator 120 authenticating the account credentials as described above, the authenticator 120 or the profile configurator 122 can identify a profile with which the account is linked or otherwise associated. The profile configurator 122 can determine whether the account is linked with a parent account. The profile configurator 122 can do so based on settings or an identifier indicating the profile type (e.g., parent profile or child profile) that is stored in the data structure for the profile in the profile database 130. Responsive to determining the account is linked with a parent profile, the profile configurator 122 can determine the user accessing the account can change information in child profiles linked with the parent profile. Responsive to determining the account is linked with a child profile, the profile configurator 122 can determine the user accessing the account can only view the information for the child profile. In some cases, profile configurator 122 can determine the user accessing the account associated with the child profile can view data for the parent profile and/or other child profiles linked with the same parent profile, but in a read-only mode.

The settings for the different profiles of a hierarchical data structure of a parent profile linked with one or more child profiles can differ between the profiles. For example, in some embodiments, one or a plurality of child profiles linked with a parent profile can change all or defined settings of all or defined other child profiles and/or the parent profile. Such settings can be stored in the data structures of the hierarchical data structure. The profile configurator 122 can identify the settings of the profile associated with the authenticated account and enable or otherwise provide the authenticated account access to the different profiles of the hierarchical data structure based on the settings.

The profile configurator 122 can transmit data of each or select profiles to the client device 102 responsive to the authenticator 120 authenticating the account. The profile configurator 122 can do so using the links in the hierarchical data structure. For example, the authenticator 120 can authenticate an account that is associated with a parent profile. Responsive to authenticating such an account, the profile configurator 122 can identify the parent profile in the profile database 130 and identify identifiers of child profiles from the record for the parent profile as child profiles that are linked with the parent profile. The profile configurator 122 can transmit data (e.g., current values, restrictions, transaction histories, biographical data, etc.) of the linked child profiles and/or the parent profile to the client device 102. The client device 102 can receive and display the data on a user interface to the user accessing the client device 102.

The profile configurator 122 can adjust the settings or data of profiles based on inputs received from the client device 102. For example, the authenticator 120 can authenticate an account associated with a parent profile. The profile configurator 122 can transmit data for the parent profile and the child profiles linked with the parent profile to the client device 102. A user accessing the client device 102 (e.g., a user authenticated an account associated with the parent profile) can input new restrictions for one or more of the child profiles that indicate attributes of transactions the child profiles can or cannot be used to perform. Through such inputs, the user can add new restrictions or change previously stored restrictions in the parent profile and/or the child profiles. The user can also input a value for each of the child profiles that indicates a portion or allocated amount of the parent profile. The user may do so at a user interface that limits the aggregate amount that can be allocated to each of the child profiles to the value (e.g., the total value) of the parent profile. The client device 102 can transmit the restrictions and/or values (e.g., allocated values) in a message to the profile configurator 122 with identifiers of the child profiles to which the restrictions correspond. The profile configurator 122 can receive the restrictions and/or values and update the records for child profiles in the profile database. The profile configurator 122 can do so by identifying the identifiers for the child profiles in the profile database 130 and either inserting new restrictions and/or values in the child profiles or replacing previously stored restrictions or values for the child profiles with the restrictions and/or values received from the client device 102.

The profile configurator 122 can update the restrictions and/or values based on user inputs over time. For example, at the client device 102, the user of the account associated with the parent profile can log in to the electronic platform provided by the profile configurator 122 multiple times. For each login, the profile configurator 122 can transmit data of the child profiles and/or the parent profile to the client device 102. The user can adjust, change, or remove values and/or restrictions of the child profiles at each login.

In one example, the client device 102 can transmit a request to add a restriction to a child profile to the transaction manager 104. The client device 102 can transmit the request via a user interface provided (e.g., transmitted) to the client device by the profile configurator 122. The request can include a restriction and an identifier of the child profile. The profile configurator 122 can receive the request and identify the child profile in the profile database 130 based on the identifier of the child profile. The profile configurator 122 can insert the restriction into the child profile, in some cases with other restrictions already stored in the data structure for the child profile.

In one example, the client device 102 can transmit a request to change a restriction of a child profile to the transaction manager 104. The client device 102 can transmit the request via a user interface provided (e.g., transmitted) to the client device by the profile configurator 122. The request can include a removal or change to a restriction already stored in the child profile or a new restriction to replace a restriction that is already stored in the child profile. The profile configurator 122 can receive the request and identify the child profile in the profile database 130 based on the identifier of the child profile. The profile configurator 122 can adjust or change the restriction that was requested to be changed either by adjusting the restriction (e.g., increasing or decreasing a timestamp or maximum or minimum total value or object value) or by replacing the restriction with the restriction in the request.

The transaction manager 104 can use the restrictions to and/or values of child profiles to facilitate transactions at brick-and-mortar stores or at online stores. For example, the transaction parser 124 may comprise programmable instructions that, upon execution, cause the processor 114 to identify or extract data (e.g., parse data) in transaction requests that the transaction manager 104 receives in messages over the network 106. The transaction requests can include data (e.g., transaction data, such as transaction attributes) for transactions that are performed at brick-and-mortar stores or at online stores. The transaction requests can include an identifier of a profile being used for the transaction, a value of the transaction in total (e.g., an aggregate amount of the values of each item of the transaction), values for each item being purchased in the transaction, a timestamp of the transaction, an identifier of the location (e.g., the store) of the transaction, a geographical location (e.g., latitude and longitude) of the transaction, MCCs of the group entity of the transaction, identifiers of items of the transaction, item types, or individual values of items of the transaction, etc. The transaction parser 124 can receive such transaction requests from point-of-sale devices such as terminals at brick-and-mortar stores or servers for online stores. The transaction parser 124 can identify or extract the individual pieces of data from the transaction requests using natural language processing techniques or by identifying the values in pre-configured fields (e.g., fields of a template that are dedicated to containing specific types of transaction data) that each computing device is configured to transmit to the transaction parser 124.

The transaction verifier 126 may comprise programmable instructions that, upon execution, cause the processor 114 to verify transactions. The transaction verifier 126 can verify transactions by comparing transaction data for individual transactions to restrictions and/or values of the profiles that are being used to perform the transactions. For example, the transaction parser 124 can identify or parse data from a transaction request that includes a profile identifier. The transaction verifier 126 can use the profile identifier as a key in a lookup in the profile database 130 to identify a child profile that contains a matching identifier to the profile identifier contained in the transaction request. The transaction verifier 126 can identify or extract the restrictions and/or the value of the child profile from the child profile containing the matching identifier. The transaction verifier 126 can compare the value of the transaction (e.g., the total value of the transaction) to the value of the child profile. Responsive to determining the value of the transaction exceeds the value of the child profile, the transaction verifier 126 can determine to restrict the transaction. However, responsive to determining the value of the transaction is less than the value of the child profile, the transaction verifier 126 can compare the transaction attributes of the transaction that the transaction parser 124 identified or extracted from the transaction request to the restrictions (if any) for the child profile. Based on the comparison, the transaction verifier 126 can determine whether or not to restrict the transaction of the transaction request (e.g., the transaction verifier 126 can determine to restrict the transaction responsive to determining at least one restriction is satisfied or determine not to restrict the transaction responsive to determining none of the restrictions are satisfied).

In one example, the transaction verifier 126 can apply a group entity restriction to attributes of a transaction to determine whether to restrict or enable the transaction. For example, the transaction verifier 126 can receive an identifier of a child profile and transaction data for a transaction in a transaction request. The transaction data can include an MCC. The MCC can indicate the type of the group entity (e.g., grocery store, discount store, supermarket, sporting goods store, hardware store, bookstore, etc.) at which the transaction is being performed. The transaction verifier 126 can use the identifier of the child profile to retrieve a group entity restriction for the child profile from the profile database 130. The group entity restriction can indicate or include MCCs of group entities for which the child profile can or cannot be used to perform transactions. The transaction verifier 126 can compare the MCC of the transaction request with the MCC or MCCs of the group entity restriction. Responsive to determining the MCC code of the transaction is restricted based on the comparison, the transaction verifier 126 can determine to restrict (e.g., not to facilitate) the transaction. The transaction verifier 126 can transmit a message to the computing device that transmitted the transaction request indicating not to complete the transaction. However, responsive to determining the MCC of the transaction is not restricted based on the comparison, the transaction verifier 126 can determine not to restrict (e.g., to facilitate) the transaction and transmit a message to the computing device that transmitted the transaction indicating to complete the transaction.

In one example, the transaction verifier 126 can apply a timing restriction to attributes of a transaction to determine whether to restrict or enable the transaction. In some embodiments, the transaction verifier 126 can do so responsive to determining the MCC code of the transaction is not restricted. For example, the transaction verifier 126 can receive an identifier of a child profile and transaction data for a transaction of a transaction request. The transaction data can include a timestamp. The timestamp can indicate when the transaction occurred (e.g., when a card was swiped). The transaction verifier 126 can use the identifier of the child profile to retrieve a timing restriction for the child profile from the profile database 130. The time restriction can indicate a time or date range in which the child profile can be used to perform transactions. The transaction verifier 126 can compare the timestamp with the time or date range and determine the timestamp is outside of the time or date range. Responsive to determining the timestamp is outside of the time or date range, the transaction verifier 126 can determine not to facilitate the transaction. The transaction verifier 126 can transmit a message to the computing device that transmitted the transaction request indicating to complete the transaction.

The transaction verifier 126 can first compare the value of the transaction with the value of the child profile to conserve processing resources. Comparing attributes of transactions to restrictions can require a substantial amount of resources given the large number of transactions the transaction manager 104 can manage or control. There can be multiple restrictions stored in each child profile to which to compare the transaction attributes, so first comparing the value of the transaction to the value of the child profile can reduce the processing that is required to verify the transaction. In instances in which a child profile being used for a transaction contains multiple restrictions, the transaction verifier 126 can first compare the value of the transaction to the value of the child profile and then sequentially compare the identified or extracted attributes of the transaction to the restrictions one at a time, determining to restrict the transaction if any of the restrictions are satisfied. In some cases, the transaction verifier 126 can apply item-based restrictions (e.g., restrictions on the types or costs of individual items) to the attributes last as the rules for such rules are on an item-by-item basis and can require more processing resources to complete. Accordingly, the transaction verifier 126 can conserve processing resources upon receiving thousands of transaction requests in short periods of time (e.g., every second).

Responsive to determining to restrict a transaction, the transaction verifier 126 can transmit a message to the computing device (e.g., the computing device 110) that transmitted a transaction request for the transaction that restricts the transaction. The message can include instructions not to enable the transaction. In one example, the message can include an identifier or value indicating not to perform the transaction. The computing device can receive the message, identify the identifier or value, and display an alert or message on a user interface indicating the transaction could not be completed. In some embodiments, the computing device can generate other types of feedback such as a light that indicates the transaction could not be completed. In instances in which the computing device is a computing device of an online store, the computing device can transmit a client device accessing the online store a message that causes the client device to vibrate or generate some other type of haptic feedback.

Responsive to determining to enable a transaction, the transaction verifier 126 can transmit a message (e.g., one or more data packets) to the computing device (e.g., the computing device 110) that transmitted a transaction request for the transaction that enables the transaction. The message can include instructions to enable the transaction. In one example, the message can include an identifier or value indicating to perform the transaction. The computing device can receive the message, identify the identifier or value, and display an alert or message on a user interface indicating the transaction was completed. In some embodiments, the computing device can generate other types of feedback such as a light that indicates the transaction was completed. In instances in which the computing device is a computing device of an online store, the computing device can transmit a client device accessing the online store a message that causes the client device to vibrate or generate some other type of haptic feedback.

The profile updater 128 may comprise programmable instructions that, upon execution, cause the processor 114 to update profiles based on performed transactions. The profile updater 128 can update profiles by changing the values of the profiles. For example, responsive to the transaction verifier 126 determining not to restrict a transaction, the profile updater 128 can identify a value of the transaction (e.g., the overall or aggregate total value of the transaction). The profile updater 128 can adjust the value of the child profile (e.g., a child value) associated with the transaction by the identified value of the transaction. The profile updater 128 can update the values of child profiles in this manner over time to keep the values of the child profiles up to date.

In some embodiments, the profile updater 128 can update a parent profile that is linked with the child profile based on the update to the value of the child profile. For example, the profile updater 128 can reduce the value of a child profile by a value of a transaction. The profile updater 128 can identify a parent profile that is linked with the child profile based on the link or identifier of the parent profile in the child profile in the profile database 130. The profile updater 128 can identify the value of the parent profile (e.g., a parent value). The profile updater 128 can adjust or reduce the value of the parent profile by the same amount as the adjustment or reduction of the child profile (e.g., by the value of the transaction). The profile updater 128 can similarly update the parent profile based on updates to any number of child profiles linked to the parent profile.

The profile updater 128 can update profiles in the profile database 130 based on messages that the transaction manager 104 receives from computing devices. For example, the transaction manager 104 can receive a message from a computing device that includes a value (e.g., a new value) and an identifier of a child profile. The profile updater 128 can identify the identifier of the child profile in the message and query the profile database 130 for a child profile that includes a matching identifier to the identifier in the message. The profile updater 128 can identify the child profile with a matching identifier and the value of the child profile in the profile database 130. The profile updater 128 can aggregate the value in the message with the value of the child profile in the child profile, thus generating an aggregated child value. In some embodiments, the message can include a type of value to aggregate into the child profile. The profile updater 128 can identify the type of the value of the child profile and aggregate the value in the message with the type of the value. The profile updater 128 can identify a parent profile that is linked with the child profile in the profile database 130 based on the link (e.g., the identifier of the parent profile) that is in the child profile. The profile updater 128 can identify the value of the parent profile and aggregate the value of the parent profile with the value of the message, thus generating an aggregated parent value. Accordingly, the profile updater 128 can keep each profile in the hierarchical data structures of the profile database 130 up to date.

In some embodiments, the profile updater 128 can identify the parent profile from the hierarchical database based on an identifier of the parent profile in the message (e.g., the message can include both an identifier of the parent profile and an identifier of the child profile). The profile updater 128 can query the profile database 130 for a parent profile that includes a matching identifier to the identifier of the parent profile in the message. The profile updater 128 can identify the parent profile with a matching identifier and the value of the parent profile in the profile database 130. The profile updater 128 can aggregate the value in the message with the value of the parent profile in the parent profile, thus generating an aggregated parent value.

The profile updater 128 can receive the values in messages through one or more transaction infrastructures (e.g., automated clearing house, real-time transport protocol, person-to-person, point redemption, etc.). The profile updater 128 may have established connections with computing devices of each of the one or more transaction infrastructures. For example, a first computing device can transmit a value and an identifier of a child profile to the data processing system through computing devices of a first transaction infrastructure. A second computing device can transmit a value and the identifier of the child profile to the data processing system through computing devices of a second transaction infrastructure. The profile updater 128 can receive each message and update the child profile according to the values in each message. Accordingly, computing devices can update child profiles using different transaction infrastructures.

The profile updater 128 can update the parent profile instead of or in addition to updating a child profile. For example, the profile updater 128 can receive a message that includes a value and an identifier of a parent profile but not an identifier of any child profiles. The profile updater 128 can determine the message does not contain an identifier of any child profiles by parsing the message and determining the message does not contain identifiers of any child profiles. Responsive to determining the message does not contain an identifier identifying any child profiles, the profile updater 128 can aggregate the value with a value of the parent profile without adjusting any values of any child profiles linked with the parent profile (e.g., without searching for links between the parent profile and any child profiles).

In one example, the profile updater 128 can update a child profile subsequent to the transaction verifier 126 determining to restrict a transaction. For example, the transaction verifier 126 can receive a transaction request with an identifier of a child profile and attributes for a transaction (e.g., a second transaction). The transaction verifier 126 can compare the value of the transaction with a value for the child profile identified in the request. Based on the comparison, the transaction verifier 126 can determine to restrict the transaction because the value of the transaction exceeds the value of the child profile (e.g., the child value). Subsequent to the determination, the profile updater 128 can receive a message from a computing device. The message can include the identifier of the child profile and a value. The profile updater 128 can receive the value and update the value of the child profile and a value of a parent profile (e.g., a parent value) linked with the child profile by separately aggregating the value in the message with the values in the parent profile and the child profile. The transaction verifier 126 can receive a second transaction request including a value for a transaction and attributes of the transaction (e.g., the same value and transaction attributes that the transaction verifier 126 received for the previously rejected transaction, except for a timestamp, which can be later than the timestamp of first transaction). The transaction verifier 126 can compare the value of the transaction to the aggregated value of the child profile and determine the aggregated value of the child profile is higher than the value of the transaction. Responsive to the determination, the transaction verifier 126 can compare the transaction attributes of the transaction to the restrictions of the child profile. Responsive to determining none of the restrictions are satisfied, the transaction verifier 126 can determine to facilitate or not restrict the transaction. The transaction verifier 126 can transmit a message (e.g., a data packet) to the computing device that transmitted the second transaction request to enable the transaction.

In one example, different child profiles can have different restrictions. For example, the transaction verifier 126 can receive transaction requests from multiple computing devices (e.g., point-of-sale devices). Each transaction request can include an identifier of a different child profile and different transaction attributes. The transaction verifier 126 can identify the child profiles that correspond to the identifiers of the child profiles in the transaction requests from the profile database 130. The transaction verifier 126 can retrieve the restrictions and/or the values of the child profile from each of the identified child profiles and apply the restrictions and/or the values of the child profiles to the values and transaction attributes in the transaction requests. Based on the comparisons, the transaction verifier 126 can determine which transactions to restrict and which transactions not to restrict. The transaction verifier 126 can transmit messages (e.g., in data packets) to the computing devices that transmitted the transaction requests with indications of whether to enable or restrict the transaction based on the determinations.

In one example, the profile updater 128 can update values of parent profiles based on values of child profiles that are in different formats (e.g., cryptocurrency (crypto), credit, cash, etc.). For instance, the profile updater 128 can generate an aggregated value for the parent profile by aggregating a value of a first child profile with a credit profile type, a value of a second child profile with a credit type, and/or a value of a third child profile with a crypto type. The profile updater 128 can convert the value of the crypto type into a cash type based on a conversion factor (e.g., a stored conversion factor or a conversion factor the profile updater 128 retrieves from an external database). The profile updater 128 can aggregate the converted value from the crypto type and the values of the cash and credit types to generate the aggregated value for the parent profile.

The profile updater 128 can adjust the aggregated value for the parent profile based on messages the profile updater 128 receives from client devices. For example, the profile updater 128 can receive a message with a value having the cash format and an identifier of the first child profile with the value of the cash type. The profile updater 128 can also receive a message with a value having the crypto format and an identifier of the third child profile with the value of the crypto type. The profile updater 128 can aggregate the value with the cash type with the value of the first child profile having the cash type and separately aggregate the value with the crypto type with the value of the third child profile having the crypto type. The profile updater 128 can convert the aggregated value of the crypto type into the cash format type and aggregate the converted value and the aggregated value of the cash type with the aggregated value of the parent profile to generate an updated aggregated value for the parent profile. The profile updater 128 can store the updated parent profile in the data structure of the parent profile in the profile database 130.

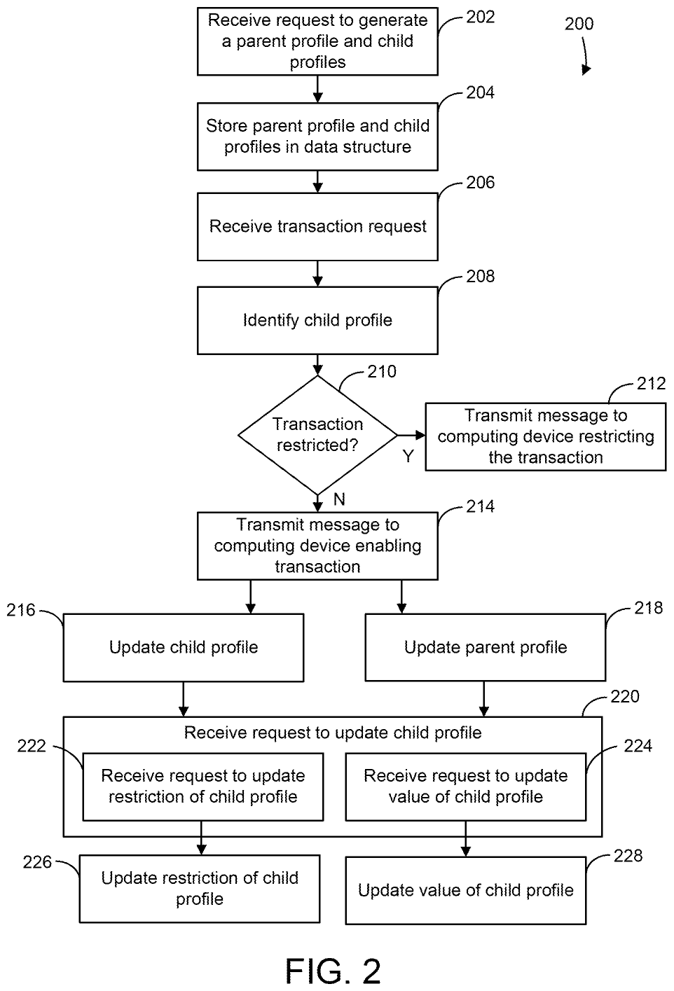

FIG. 2 is an illustration of an example method 200 for remote transaction control, in accordance with an implementation. The method 200 can be performed by a data processing system (e.g., a client device or the transaction manager 104, shown and described with reference to FIG. 1, a server system, etc.). The method 200 may include more or fewer operations and the operations may be performed in any order. Performance of the method 200 may enable the data processing system to remotely control point-of-sale devices to enable or restrict transactions occurring at the point-of-sale devices. The data processing system can do so using a hierarchical data structure that enables accounts associated with parent profiles to insert, remove, and/or otherwise adjust restrictions placed on child profiles of the hierarchical data structure. When a user of one of the child profiles attempts to perform a transaction, the data processing system can compare the value and/or attributes of the transaction with the value and/or restrictions of the child profile to determine whether to restrict or enable the transaction. The data processing system can make the determination and transmit an indication of whether to complete or restrict (e.g., stop) the transaction from occurring. In this way, the data processing can remotely control transactions at different locations using restrictions without requiring the computing devices performing the transactions to store any data for individual users or profiles. As described herein, references to messages can be references to one or more data packets, and vice versa.

At operation 202, the data processing system receives a request to generate a parent profile and child profiles. The data processing system can receive the request from a client device. The request can include a value for the parent profile (e.g., a parent value) and a value for each of the child profiles (e.g., child values). The sum of the values for the child profiles cannot exceed the value of the parent profile. The request can also include restrictions for each of the child profiles. Responsive to receiving the request, the data processing system can generate a record in a database for the requested parent profile and child profiles. Each record can include the value for the profile of the record and any restrictions placed on the profile. Records for the child profiles can each include an identifier of the parent profile and/or the parent profile can include identifiers of the child profiles. Such identifiers can link the child profiles with the parent profile. At operation 204, the data processing system stores the records for the profiles in a data structure (e.g., a database) to generate a hierarchical data structure.

At operation 206, the data processing system receives a transaction request. The data processing system can receive the transaction request from a computing device. The computing device can be a point-of-sale device (e.g., a computing device at a brick-and-mortar store or a computing device that maintains an online store). The transaction request can include a value and attributes of the transaction as well as an identifier of a profile. The value, the attributes, and/or the identifier of the profile can be included in the transaction request as a single string.

At operation 208, the data processing system identifies a child profile. The data processing system can use the identifier of the profile in the transaction request to query the database with the hierarchical data structure. The data processing system can identify a child profile from the database that has an identifier that matches the identifier of the profile in the transaction request. The profile can be a child profile that includes a value and restrictions as well as a link with a parent profile.

At operation 210, the data processing system determines whether the transaction is restricted. The data processing system can do so by comparing the value of the transaction with the value of the child profile. Responsive to determining the value of the transaction exceeds the value of the child profile, the data processing system can determine to restrict the transaction. However, responsive to determining the value of the transaction does not exceed the value of the child profile, the data processing system can compare the transaction attributes with the restrictions of the child profile. Responsive to determining at least one of the restrictions is satisfied, the data processing system can determine to restrict the transaction (e.g., the transaction is restricted). Otherwise, the data processing system can determine not to restrict the transaction (e.g., the transaction is not restricted).

Responsive to determining the transaction is restricted, at operation 212, the data processing system transmits a message to the computing device restricting the transaction. The message can include an indication or identifier that the transaction is restricted. The computing device can receive the message and generate an alert (e.g., an auditory or visual signal) that the transaction has been denied.

Responsive to determining the transaction is not restricted (e.g., enabled), at operation 214, the data processing system transmits a message to the computing device to the computing device indicating the transaction is enabled. The message can include an indication or identifier that the transaction is not restricted or is enabled. The computing device can receive the message and generate an alert (e.g., an auditory or visual signal) that the transaction has been accepted.

At operation 216, the data processing system updated the child profile. The data processing system updates the child profile by adjusting the value of the child profile. For example, the data processing can subtract from or reduce the value of the child profile by the value of the transaction that the data processing system enabled.

In some embodiments, instead of or in addition to updating the child profile, at operation 218, the data processing system updates a parent profile linked with the child profile. The data processing system can identify the parent profile from an identifier of the parent profile that is stored in the child profile. The data processing system can identify the value of the parent profile and subtract from or reduce the value of the parent profile by the amount of the transaction that the data processing system enabled.

At operation 220, the data processing system receives a request to update a child profile (e.g., the same child profile as was used to perform the transaction in operations 206-218). The request 222 can be a request to update a restriction of the child profile or a request to update a value of the child profile 224. The data processing system can determine whether it is a request to update a restriction or a value of the child profile by identifying the values in the body of the message of the request.

Responsive to determining the request is a request to update a restriction of the child profile, at operation 226, the data processing system updates the restriction of the child profile. The data processing system can identify the record of the child profile from the database based on the record containing an identifier of the child profile that matches an identifier of the child profile in the request. The data processing system can update the restriction by changing a value or string of a stored restriction in the child profile, adding a restriction to the child profile, or removing a restriction from the child profile, depending on the request. The data processing system can update the restriction in the child profile and store the updated child profile back in the database.

Responsive to determining the request is a request to update a value of the child profile, at operation 228, the data processing system updates the value of the child profile. The data processing system can identify the record of the child profile from the database based on the record containing an identifier of the child profile that matches an identifier of the child profile in the request. The data processing system can update the value by aggregating the value in the request with the value that is stored in the child profile. In some embodiments, the data processing system can identify a parent profile that is linked with the child profile based on an identifier of the parent profile stored in the child profile. The data processing system can aggregate the value of the request with the value of the parent profile to update the value of the parent profile. The data processing system can update the value in the child profile and/or the parent profile and store the updated child profile and/or parent profile back in the database.

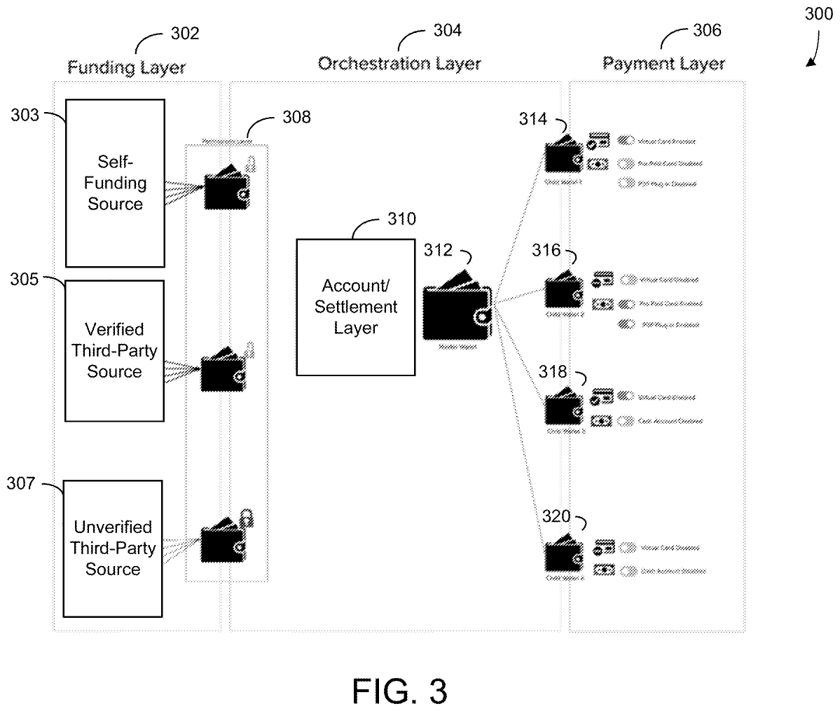

FIG. 3 is an illustration of layers of a system 300 for remote transaction control, in accordance with an implementation. The system can be managed by a data processing system (e.g., the transaction manager 104). The system 300 can include a funding layer 302, an orchestration layer 304, a payment layer 306, a permissions layer 308, and an accounting/settlement layer 310. The funding layer 302 includes three different types of funding sources. One type of funding source is a self-funding source 303. The self-funding source 303 can be or include the owner of an account that corresponds to a parent profile 312. The owner can access the account and input values to the parent profile via the account. The owner can additionally allocate portions of the input values and/or insert restrictions into one or more of the child profiles 314, 316, 318, and/or 320. Updates to the profiles can settle at the accounting/settlement layer 310.

Another type of source is a verified third-party source 305. The verified third-party source 305 sources can be accounts that have been previously registered or verified with the platform that provided by the data processing system. The verified third-party source 305 can transmit messages to the data processing system. The messages can include values and identifiers of child profiles to update with the values. The data processing system can receive the messages and determine the verified third-party sources 305 are verified (e.g., by identifying identifiers of the verified third-party sources 305, comparing the identifiers to a database, and determining the identifiers are associated with an indication that the verified third-party sources 305 are verified or registered). Responsive to the determinations, the data processing system can update the child profiles 314, 316, 318, and/or 320 with the values in addition to the parent profile 312.

Another type of source is an unverified third-party source 307. The unverified third-party source 307 can be an entity that is not registered or has otherwise not been verified by the data processing system. The unverified third-party source 307 can transmit messages to the data processing system containing values and/or identifiers of the child profiles 314, 316, 318, and/or 318. The data processing system can receive the messages and determine the unverified third-party sources 307 are unverified (e.g., by identifying identifiers of the unverified third-party sources 307, comparing the identifiers to a database, and determining the identifiers do not have a matching identifier in the database or determining the identifiers are associated with an indication that the unverified third-party sources 307 are not verified or registered). Responsive to the determination, the data processing system can determine to reject the requested updated to any child profiles identified in the messages.

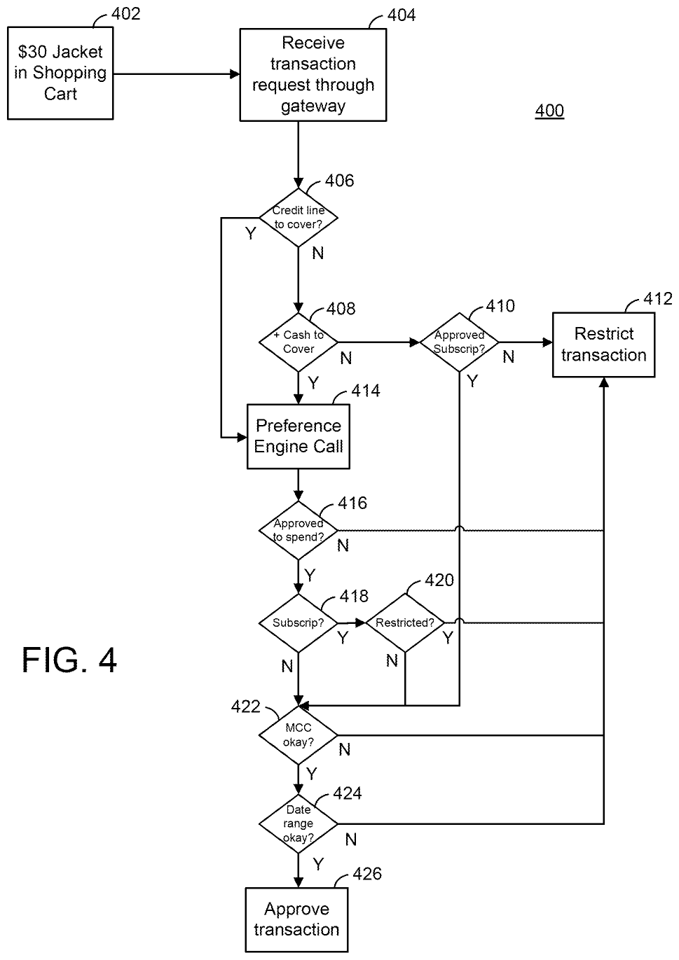

FIG. 4 is an illustration of a method 400 for remote transaction control, in accordance with an implementation. The method 400 can be performed by a data processing system (e.g., a client device or the transaction manager 104, shown and described with reference to FIG. 1, a server system, etc.). The method 400 may include more or fewer operations and the operations may be performed in any order. The method 400 can performed concurrently or be the same as the method 200.

At an operation 402, a user selects an object to place in a shopping cart (e.g., an online shopping cart or a real-world shopping cart). At an operation 404, the user inputs data or an identifier of a transaction card that corresponds to a child profile that is maintained by the data processing system into a computing device (e.g., a server or point-of-sale device) for a transaction. The computing device can transmit a request that contains the identifier and data (e.g., a value and transaction attributes) for the transaction to the data processing system. The data processing system can receive the request. At operation 406, the data processing system determines whether the child profile has access to a credit line with a value that is at least equal to the value of the transaction. Responsive to determining the child profile does not have access to a credit line with a sufficient value, at operation 408, the data processing system determines whether the child profile has access to a value of cash in combination with a value of a credit line (e.g., a sum of the cash plus the credit line) to exceed the value of the transaction.

Responsive to determining the value of the credit line in combination with the value of the cash is less than the value of the transaction, at operation 410, the data processing system determines whether the transaction is associated with an approved subscription (e.g., a recurring or automated transaction) for the child profile. A subscription can be a subscription for a product or service that involves recurrent or periodic transactions (e.g., payments that occur at set time intervals). Transaction requests for subscriptions can include an identifier (e.g., a subscription identifier) that indicates the transaction requests correspond to a subscription and/or a subscription type that indicates the product or service that the subscription is for. An approved subscription can be a subscription for which a child profile has a stored object, flag, or setting that indicates the child profile is authorized or approved to perform or facilitate transactions for the subscription. The stored object, flag, or setting can include an identifier of the subscription type of the approved subscription. The data processing system can determine whether the transaction is associated with an approved subscription by determining whether the transaction request includes a subscription identifier and/or a subscription type. Responsive to determining the transaction request includes a subscription identifier and/or subscription type, the data processing system can identify the subscription type and compare the subscription type with any subscription types stored in the child profile. The data processing system can determine the transaction is associated with an approved subscription responsive to identifying a match based on the comparison or determine the transaction is not associated with an approved subscription responsive to determining there is not a match based on the comparison.

Responsive to determining the child profile is not associated with an approved subscription, at operation 412, the data processing system determines to restrict the transaction. The data processing system can transmit a message to the computing device that transmitted the transaction request for the transaction indicating to restrict or reject the transaction.

Responsive to the data processing system determining the value of the credit line of the child profile exceeds the value of the transaction or value of the credit line in combination with the value of the cash of the child profile exceeds the value of the transaction, at operation 414, the data processing system calls a preference engine service. The preference engine service can be an application programming interface (API) or application that is configured to determine whether or not to restrict transactions. The preference engine service can be the same as or similar to the transaction verifier 126, shown and described with reference to FIG. 1. At operation 416, the data processing (e.g., via the preference engine service) determines whether the child profile is approved to perform transactions. The data processing system can do so by identifying a flag or setting in the child profile that indicates whether the child profile can be used to perform transactions. Responsive to determining the child profile is not approved to perform transactions, the data processing system can return to the operation 412 and restrict the transaction (e.g., transmit a message to the computing device that transmitted the transaction request to restrict, stop, or decline the transaction).

However, responsive to determining the child profile is approved to perform transactions, at operation 418, the data processing system determines whether the transaction is for a subscription (e.g., an initiation or beginning of a subscription or a payment for a subscription). The data processing system may determine whether the transaction is for a subscription based on whether the message (e.g., an ISO 8583 or ISO 2102 message) of the transaction request includes an identifier (e.g., a subscription identifier) that indicates the transaction requests correspond to a subscription. The data processing system can determine the transaction is for a subscription responsive to determining the message includes the subscription identifier. The data processing system can determine the transaction is not for a subscription responsive to determining the message does not include the subscription identifier.

Responsive to determining the transaction request is associated with a subscription, at operation 420, the data processing system determines whether the subscription is restricted. The data processing system may do so, for example, by analyzing a subscription type identifier in the message for the transaction request. For example, the data processing system may identify the subscription type identifier and compare the subscription identifier to one or more rules or restrictions stored in the child profile. The one or more rules or restrictions can indicate subscription types for which the profile is enabled or allowed to initiate and/or subscription types for which the profile is restricted from initiating or completing transactions. In one example, the profile can include a list of identifiers of subscription types for which the profile is enabled or restricted from initiating a subscription or completing transactions for the subscription. The data processing system can compare the identifier of the subscription to the one or more rules or restrictions to determine if the transaction for the subscription should be restricted based on the subscription type of the subscription.

In some embodiments, the child profile may be restricted from completing a transaction for a subscription based on characteristics of the subscription. For example, the message for the subscription transaction may include characteristics (e.g., type, size, or transaction or payment frequency) of the subscription. In some cases, the data processing system can store such characteristics of subscription for different subscription types in memory. The data processing system can identify the characteristics of the subscription from the message or from memory based on the identifier of the subscription in the message. The data processing system can compare the characteristics to one or more rules or restrictions indicating the characteristics of subscriptions for which the child profile is restricted from completing. The data processing system can determine whether to restrict the subscription transaction based on the comparison.

Responsive to determining the transaction is not for a subscription or is not restricted based on a subscription rule, at operation 422, the data processing system determines whether the MCC of the transaction is approved for the child profile. The data processing system can identify the MCC of the transaction from the transaction attributes in the transaction request. The data processing system can compare the MCC with restrictions in the child profile that indicate MCCs of transactions that the child profile is not restricted from performing or MCCs of transactions that the child profile cannot perform. The data processing system can compare the MCC of the transaction with the restrictions and determine whether to restrict the transaction based on the comparison. Responsive to determining to restrict the transaction based on the MCC of the transaction, the data processing system can return to the operation 412 and restrict the transaction.

Responsive to determining the transaction is not restricted based on the MCC of the transaction, at operation 424, the data processing system determines (e.g., via the preference engine call) whether to restrict the transaction based on the time of the transaction. For example, the data processing system can receive a timestamp for the transaction indicating the payment presentment (e.g., time of a swipe) for the transaction at a brick-and-mortar store, a time of selecting a purchase option on an online store, or a time of transmission of the message for the transaction. The timestamp can include such a time and/or a date of the transaction. The data processing system can compare the timestamp to a restriction that includes a date range in which transactions can or cannot be performed by the child profile. Based on the comparison the data processing system can determine whether or not to restrict the transaction. Responsive to determining to restrict the transaction based on the timestamp of the transaction, the data processing system can return to the operation 412 and restrict the transaction.

Responsive to determining not to restrict the transaction, at operation 426, the data processing system approves the transaction. The data processing system can approve the transaction by transmitting a message to the computing device that transmitted the transaction request. The message can include an indication to complete, enable, or otherwise facilitate the transaction. The computing device can receive the message and generate an alert indicating the transaction was completed successfully. The data processing system can update a value of the child profile by reducing the value of the child profile by the value of the subscription.

In cases in which the data processing system determines to approve a transaction responsive to determining the transaction is for an approved subscription at the operation 410, the data processing system can complete the transaction based on a value of the parent profile associated with the child profile. For example, the child profile may include a value that is lower than the value of the approved subscription transaction. Responsive to determining the value is lower and that the transaction is for an approved subscription, the data processing system may complete the transaction by reducing the value of the parent profile associated with the child profile by the difference between the value of the child profile and the value of the transaction for the approved subscription and, if not already zero, reduce the value of the child profile to zero. The data processing system may transmit a message to computing device for the approved transaction to complete the transaction.

In some embodiments, the data processing system may insert an identification of the difference (e.g., the difference itself) between the value of the child profile and the value of the transaction into the child profile. The difference may indicate an amount to transfer to the parent profile upon an increase in the value of the child profile. For example, the data processing system may insert a difference value of five into the child profile. The data processing system may receive an indication to update the value of the child profile by 10. Responsive to receiving the indication, the data processing system may increase the value of the parent profile by the difference (e.g., five) and increase the value of the child profile by the remaining amount (e.g., five).

At least one aspect of a technical solution to the aforementioned problem is directed to a transaction processing server for facilitating profile restrictions for transactions. The server can include a processor coupled with memory and a network interface, the processor storing, in the memory, a data structure comprising a parent profile comprising a parent value linked with one or more child profiles, each child profile comprising a child restriction and a child value linked with the parent value, the child restriction and the child value configured by an account associated with the parent profile; receiving, via the network interface from a computing device, a transaction request comprising a value, a transaction attribute, and an identifier of a first child profile of the one or more child profiles; determining whether to facilitate a transaction of the transaction request based on a first comparison between the value and a first child value of the first child profile and a second comparison between the transaction attribute and a first child restriction of the first child profile; and responsive to determining not to facilitate the transaction based on the first comparison and the second comparison, transmitting, via the network interface, a data packet to the computing device restricting the transaction from occurring.

In some embodiments, the processor receives, via the network interface from a client device, a new value and an identifier of the first child profile; and aggregates the new value with the child value and separately based on a link between the parent value and first child value, the new value with the parent value. In some embodiments, the processor generates an aggregated child value based on the aggregating the new value with the first child value. The processor can receive, via the network interface from the computing device, a second transaction request comprising a second value, a second transaction attribute, and the identifier of the first child profile of the one or more child profiles; determine whether to facilitate a transaction of the second transaction request based on a third comparison between the second value and the aggregated value of the first child profile and a fourth comparison between the transaction attribute and the first child restriction of the first child profile; and responsive to determining to facilitate the transaction of the second transaction request based on the third comparison and the fourth comparison, transmit, via the network interface, a data packet to the computing device enabling the transaction to occur.

In some embodiments, the processor receives, via the network interface, a second child restriction and an identifier of the first child profile; and inserts the second child restriction into the first child profile. In some embodiments, the processor receives, via the network interface from a client device, a request to change the first child restriction; and adjusts the first child restriction according to the request. In some embodiments, the processor provides a user interface to the client device comprising fields for authentication; authenticates a user according to credentials associated with the account associated with the parent profile; and receives the request to change the first child restriction from the account associated with the parent profile.

In some embodiments, the processor receives, via the network interface from a second computing device, a second transaction request comprising a second value, a second transaction attribute, and an identifier of a second child profile of the one or more child profiles; determines to facilitate a transaction of the second transaction request based on a third comparison between the second value and a second child value of the second child profile and a fourth comparison between the second transaction attribute and a second child restriction of the second child profile;

and responsive to determining to facilitate the transaction based on the third comparison and the fourth comparison, transmits, via the network interface, a second data packet to the second computing device enabling the transaction to occur.

In some embodiments, the processor receives the transaction attribute by receiving a timestamp of the transaction. The processor can compare the timestamp with a time or date range of the first child restriction; and determining not to facilitate the transaction responsive to determining the timestamp is outside of the time or date range. In some embodiments, the processor receives the transaction request comprising a type of object of the transaction and a timestamp of the transaction; compares the type of object to a second child restriction of the first child profile; responsive to determining the type of object does not satisfy the second child restriction, compares the timestamp with a time or date range of the first child restriction; and determines not to facilitate the transaction responsive to determining the timestamp is outside of the time or date range.

In some embodiments, the processor receives, via the network interface, a first value from a first client device and a second value from a second client device, the first value having a first format and the second value having a second format; aggregates the first value, the second value, and an aggregated value for the parent profile to generate an updated aggregated value for the parent profile; and stores the updated aggregated value in the parent profile in the data structure. In some embodiments, the processor adjusts the second value according to the first format and the second format, wherein the processor aggregates the first value, the second value, and the aggregated value by aggregating the first value, the adjusted second value, and the aggregated value.

In some embodiments, the processor receives, via the network interface from a client device, a message comprising a new value without an identifier identifying any child profiles; determines the message does not contain an identifier identifying any child profiles; and responsive to the determining the message does not contain an identifier identifying any child profiles, aggregates the new value with a value of the parent profile without adjusting any values of the one or more child profiles.

Another aspect of a technical solution to the aforementioned technical problem relates to a method. The method can include storing, by a processor in memory, a data structure comprising a parent profile comprising a parent value linked with one or more child profiles, each child profile comprising a child restriction and a child value linked with the parent value, the child restriction and the child value configured by an account associated with the parent profile; receiving, by the processor from a computing device, a transaction request comprising a value, a transaction attribute, and an identifier of a first child profile of the one or more child profiles; determining, by the processor, whether to facilitate a transaction of the transaction request based on a first comparison between the value and a first child value of the first child profile and a second comparison between the transaction attribute and a first child restriction of the first child profile; and responsive to determining not to facilitate the transaction based on the first comparison and the second comparison, transmitting, by the processor, a data packet to the computing device restricting the transaction from occurring.

In some embodiments, the method includes receiving, via the network interface from a client device, a new value and an identifier of the first child profile; and aggregating the new value with the child value and, separately based on a link between the parent value and first child value, the new value with the parent value.

In some embodiments, aggregating the new value with the first child value comprises aggregating, by the processor, the new value with the first child value to generate an aggregated child value. The method can include receiving, by the processor from the computing device, a second transaction request comprising the value, the transaction attribute, and the identifier of the first child profile of the one or more child profiles; determining, by the processor, whether to facilitate a transaction of the second transaction request based on a third comparison between the value and the aggregated value of the first child profile and a fourth comparison between the transaction attribute and the first child restriction of the first child profile; and responsive to determining to facilitate the transaction based on the third comparison and the fourth comparison, transmitting, by the processor, a data packet to the computing device enabling the transaction to occur.

In some embodiments, the method includes receiving, by the processor, a second child restriction and an identifier of the first child profile; and inserting, by the processor, the second child restriction into the first child profile. In some embodiments, the method includes receiving, by the processor from a client device, a request to change the first child restriction; and adjusting by the processor, the first child restriction according to the request. In some embodiments, the method includes providing, by the processor, a user interface to the client device comprising fields for authentication; authenticating, by the processor, a user according to credentials associated with the account associated with the parent profile; and receiving, by the processor, the request to change the first child restriction from the account associated with the parent profile.

Another aspect of a technical solution to the aforementioned technical problem relates to a non-transitory computer-readable storage medium having instructions embodied thereon, the instructions being executable by one or more processors to perform a method. The method may include storing, in memory, a data structure comprising a parent profile comprising a parent value linked with one or more child profiles, each child profile comprising a child restriction and a child value linked with the parent value, the child restriction and the child value configured by an account associated with the parent profile; receiving, from a computing device, a transaction request comprising a value, a transaction attribute, and an identifier of a first child profile of the one or more child profiles; determining whether to facilitate a transaction of the transaction request based on a first comparison between the value and a first child value of the first child profile and a second comparison between the transaction attribute and a first child restriction of the first child profile; and responsive to determining not to facilitate the transaction based on the first comparison and the second comparison, transmitting a data packet to the computing device restricting the transaction from occurring.

In some embodiments, the method includes receiving, from a client device, a new value and an identifier of the first child profile; and aggregating the new value with the parent value and, separately based on the identifier of the first child profile and a link between the parent value and first child value, the new value with the first child value.

These and other aspects and implementations are discussed in detail herein. The information and the detailed description provided herein include illustrative examples of various aspects and implementations and provide an overview or framework for understanding the nature and character of the claimed aspects and implementations. The drawings provide illustration and a further understanding of the various aspects and implementations and are incorporated in and constitute a part of this specification.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “computing device” or “component” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of client device 102 or the transaction manager 104) to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks. The processor and the memory can be supplemented by, or incorporated in, special purpose logic circuitry.

While operations are depicted in the drawings in a particular order, such operations are not required to be performed in the particular order shown or in sequential order, and all illustrated operations are not required to be performed. Actions described herein can be performed in a different order. The separation of various system components does not require separation in all implementations, and the described program components can be included in a single hardware or software product.

The phraseology and terminology used herein is for the purpose of description and should not be regarded as limiting. Any references to implementations or elements or acts of the systems and methods herein referred to in the singular may also embrace implementations including a plurality of these elements, and any references in plural to any implementation or element or act herein may also embrace implementations including only a single element. Any implementation disclosed herein may be combined with any other implementation or embodiment.

References to “or” may be construed as inclusive so that any terms described using “or” may indicate any of a single, more than one, and all the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A transaction processing server for facilitating profile restrictions for transactions, the server comprising:
a processor coupled with memory and a network interface, the processor:
storing, in the memory, a data structure comprising a parent profile comprising a parent value linked with one or more child profiles, each child profile comprising a child restriction and a child value linked with the parent value, the child restriction and the child value configured by an account associated with the parent profile;
receiving, via the network interface from a computing device, a transaction request comprising a value, a transaction attribute, and an identifier of a first child profile of the one or more child profiles;
determining whether to facilitate a transaction of the transaction request based on a first comparison between the value and a first child value of the first child profile and a second comparison between the transaction attribute and a first child restriction of the first child profile; and
responsive to determining not to facilitate the transaction based on the first comparison and the second comparison, transmitting, via the network interface, a data packet to the computing device restricting the transaction from occurring.

2. The server of claim 1, the processor:
receiving, via the network interface from a client device, a new value and an identifier of the first child profile; and
aggregating the new value with the child value and, separately based on a link between the parent value and first child value, the new value with the parent value.

3. The server of claim 2, wherein the processor generates an aggregated child value based on the aggregating the new value with the first child value, the processor:
receiving, via the network interface from the computing device, a second transaction request comprising a second value, a second transaction attribute, and the identifier of the first child profile of the one or more child profiles;
determining whether to facilitate a transaction of the second transaction request based on a third comparison between the second value and the aggregated value of the first child profile and a fourth comparison between the transaction attribute and the first child restriction of the first child profile; and
responsive to determining to facilitate the transaction of the second transaction request based on the third comparison and the fourth comparison, transmitting, via the network interface, a data packet to the computing device enabling the transaction to occur.

4. The server of claim 1, the processor:
receiving, via the network interface, a second child restriction and an identifier of the first child profile; and
inserting the second child restriction into the first child profile.

5. The server of claim 1, the processor:
receiving, via the network interface from a client device, a request to change the first child restriction; and
adjusting the first child restriction according to the request.

6. The server of claim 5, the processor:
providing a user interface to the client device comprising fields for authentication;
authenticating a user according to credentials associated with the account associated with the parent profile; and
receiving the request to change the first child restriction from the account associated with the parent profile.

7. The server of claim 1, the processor:
receiving, via the network interface from a second computing device, a second transaction request comprising a second value, a second transaction attribute, and an identifier of a second child profile of the one or more child profiles;
determining to facilitate a transaction of the second transaction request based on a third comparison between the second value and a second child value of the second child profile and a fourth comparison between the second transaction attribute and a second child restriction of the second child profile; and
responsive to determining to facilitate the transaction based on the third comparison and the fourth comparison, transmitting, via the network interface, a second data packet to the second computing device enabling the transaction to occur.

8. The server of claim 1, wherein the processor receives the transaction attribute by receiving a timestamp of the transaction, the processor:
comparing the timestamp with a time or date range of the first child restriction; and
determining not to facilitate the transaction responsive to determining the timestamp is outside of the time or date range.

9. The server of claim 1, the processor:
receiving the transaction request comprising a type of object of the transaction and a timestamp of the transaction;
comparing the type of object to a second child restriction of the first child profile;
responsive to determining the type of object does not satisfy the second child restriction, comparing the timestamp with a time or date range of the first child restriction; and
determining not to facilitate the transaction responsive to determining the timestamp is outside of the time or date range.

10. The server of claim 1, the processor:
receiving, via the network interface, a first value from a first client device and a second value from a second client device, the first value having a first format and the second value having a second format;
aggregating the first value, the second value, and an aggregated value for the parent profile to generate an updated aggregated value for the parent profile; and
storing the updated aggregated value in the parent profile in the data structure.

11. The server of claim 10, the processor:
adjusting the second value according to the first format and the second format,
wherein the processor aggregates the first value, the second value, and the aggregated value by aggregating the first value, the adjusted second value, and the aggregated value.

12. The server of claim 1, the processor:
receiving, via the network interface from a client device, a message comprising a new value without an identifier identifying any child profiles;
determining the message does not contain an identifier identifying any child profiles; and
responsive to the determining the message does not contain an identifier identifying any child profiles, aggregating the new value with a value of the parent profile without adjusting any values of the one or more child profiles.

13. A method, comprising:
storing, by a processor in memory, a data structure comprising a parent profile comprising a parent value linked with one or more child profiles, each child profile comprising a child restriction and a child value linked with the parent value, the child restriction and the child value configured by an account associated with the parent profile;
receiving, by the processor from a computing device, a transaction request comprising a value, a transaction attribute, and an identifier of a first child profile of the one or more child profiles;
determining, by the processor, whether to facilitate a transaction of the transaction request based on a first comparison between the value and a first child value of the first child profile and a second comparison between the transaction attribute and a first child restriction of the first child profile; and
responsive to determining not to facilitate the transaction based on the first comparison and the second comparison, transmitting, by the processor, a data packet to the computing device restricting the transaction from occurring.

14. The method of claim 13, comprising:
receiving, by the processor from a client device, a new value and an identifier of the first child profile; and
aggregating, by the processor, the new value with the child value and, separately based on a link between the parent value and first child value, the new value with the parent value.

15. The method of claim 14, wherein aggregating the new value with the first child value comprises aggregating, by the processor, the new value with the first child value to generate an aggregated child value, the method comprising:
receiving, by the processor from the computing device, a second transaction request comprising a second value, a second transaction attribute, and the identifier of the first child profile of the one or more child profiles;
determining, by the processor, whether to facilitate a transaction of the second transaction request based on a third comparison between the second value and the aggregated value of the first child profile and a fourth comparison between the transaction attribute and the first child restriction of the first child profile; and
responsive to determining to facilitate the transaction of the second transaction request based on the third comparison and the fourth comparison, transmitting, by the processor, a data packet to the computing device enabling the transaction to occur.

16. The method of claim 13, comprising:
receiving, by the processor, a second child restriction and an identifier of the first child profile; and
inserting, by the processor, the second child restriction into the first child profile.

17. The method of claim 13, comprising:
receiving, by the processor from a client device, a request to change the first child restriction; and
adjusting by the processor, the first child restriction according to the request.

18. The method of claim 17, comprising:
providing, by the processor, a user interface to the client device comprising fields for authentication;
authenticating, by the processor, a user according to credentials associated with the account associated with the parent profile; and
receiving, by the processor, the request to change the first child restriction from the account associated with the parent profile.

19. A non-transitory computer-readable storage medium having instructions embodied thereon, the instructions being executable by one or more processors to perform a method, the method comprising:
storing, in memory, a data structure comprising a parent profile comprising a parent value linked with one or more child profiles, each child profile comprising a child restriction and a child value linked with the parent value, the child restriction and the child value configured by an account associated with the parent profile;
receiving, from a computing device, a transaction request comprising a value, a transaction attribute, and an identifier of a first child profile of the one or more child profiles;
determining whether to facilitate a transaction of the transaction request based on a first comparison between the value and a first child value of the first child profile and a second comparison between the transaction attribute and a first child restriction of the first child profile; and
responsive to determining not to facilitate the transaction based on the first comparison and the second comparison, transmitting a data packet to the computing device restricting the transaction from occurring.

20. The non-transitory computer-readable storage medium of claim 19, the method comprising:
receiving, from a client device, a new value and an identifier of the first child profile; and
aggregating the new value with the child value and, separately based on a link between the parent value and first child value, the new value with the parent value.
